(19) United States
(12) Patent Application Publication
(10) Pub. No.: US 2010/0050706 A1
(43) Pub. Date: Mar. 4, 2010

(54) Releasable security mount

(75) Inventor: Edward L. O'Neill, Oakland, CA (US)

Correspondence Address: Niro, Scavone, Haller & Niro;Suite 4600, 181 W. Madison, Chicago, IL, 60602, US

(73) Assignee: Lucasey Manufacturing Company

(21) Appl. No.: 12/231,470

(22) Filed: Sep. 3, 2008

(51) Int. Cl. E05B 73/00; A47G 29/00

(52) U.S. Cl. 70/58; 248/346.01

(57) ABSTRACT

An apparatus for securely mounting an appliance to a support surface having interlocking components that securely mount the appliance yet may be easily installed and uninstalled.

### BACKGROUND OF THE INVENTION

The present inventions relate to an apparatus for mounting appliances to support surfaces. More particularly, the present inventions relate to an appliance mounting apparatus that provides interlocking components that securely mount an appliance to a support surface and which is easily locked and unlocked.

### SUMMARY OF THE INVENTION

There is a need to securely mount appliances, such as remote controls, radios and televisions to countertops, dressers, tables and other support surfaces, to prevent theft in hotels and other places. It is also necessary to securely mount such appliances while maintaining an aesthetic appearance. In addition, ease of installation and removal for maintenance or replacement are also important considerations.

The present inventions provide an apparatus for securely and releasably mounting an appliance to a support surface having a base for engaging the support surface, at least one upstanding locking post on the base, the locking post having a shaft and a head, and at least one locking aperture on the base. The present inventions also include a mounting bracket securable to said appliance, at least one keyway on the mounting bracket to cooperate with the at least one locking post, and at least one locking tab on the mounting bracket to cooperate with the locking aperture on the base. A release tool having at least one prong, the prong capable of disengaging the locking tab from the locking aperture is also provided. The locking post may include a platform or raised shoulder and the keyway may include a head opening, a shaft slot and a recessed shoulder. The support apparatus may further include a second mounting bracket or swivel plate, the second mounting bracket being securable to the appliance and pivotably mounted to the mounting bracket. In other embodiments, the locking aperture or member may be located on the mounting bracket and the cooperating locking tab may be located on the base.

The present inventions also provide a security mounting apparatus to secure an appliance to a support surface, including a base plate for attachment to the support surface, the base including at least one locking post having a shaft and a head and the base including at least one locking means, a mounting bracket securable to the appliance, the mounting bracket including at least one keyway slidably engagable with the at least one locking post and, at least one locking tab depending from the mounting bracket and engagable with the locking means, and a release member having at least one prong which is capable of disengaging the locking tab from the locking means. The security apparatus may also include a second mounting bracket or swivel plate securable to the appliance which in turn is secured to the mounting bracket. Alternatively, the base plate may include the locking member and/or locking tab and the mounting bracket may include the locking means or aperture.

A mounting apparatus for selectively locking and unlocking an appliance on a support surface is provided and includes a base plate for engaging the support surface, at least one locking post having a head and a shaft and at least one locking aperture, a mounting plate securable to the appliance, the mounting plate having at least one keyway slidably engagable with and capable of retaining the at least one locking post, at least one locking member depending from the mounting bracket and engagable with and releasable from the locking aperture, and a release member for selectively releasing the at least one locking member from the at least one locking aperture. The apparatus may also include a second mounting bracket securable to the appliance which is pivotably mounted to the mounting bracket such that the appliance may be rotated on said mounting apparatus. Alternatively, the locking member may depend from said base plate and said locking aperture may be on said mounting bracket. And, the locking aperture may be a raised member or protrusion capable of engaging or being engaged by said locking member.

### Inventor's Definition of the Terms

The terms used in the claims of this patent are intended to have their broadest meaning consistent with the requirements of law. Where alternative meanings are possible, the broadest meaning is intended. All words used in the claims are intended to be used in the normal, customary usage of grammar and the English language.

### BRIEF DESCRIPTION OF THE DRAWINGS

The stated and unstated objects, features and advantages of the present inventions (sometimes used in the singular, but not excluding the plural) will become apparent from the following descriptions and drawings, wherein like reference numerals represent like elements in the various views, and in which:

FIG. 1 is a perspective view of a preferred embodiment of the present invention in an installed or assembled position showing an exemplary appliance secured to a representative support surface, the embodiment also including an optional swivel plate or turntable;

FIG. 2 is an exploded perspective view of a preferred embodiment of the present invention showing principal components prior to assembly;

FIG. 3 is a perspective view of the embodiment of FIG. 2 shown in an assembled or locked position with portions shown in phantom line to highlight their interaction;

FIG. 4 is an exploded perspective view of another preferred embodiment of the present invention similar to that of FIG. 2 and also including an optional swivel plate and a preferred release member or key;

FIG. 5 is a perspective view of the embodiment of FIG. 4 shown in an assembled position with portions removed and/or shown in phantom line to highlight principal components and their interaction;

FIG. 6 is a side elevational view of the embodiment of FIG. 5 shown in an installation position;

FIG. 7 is a side elevational view of the embodiment of FIG. 5 from behind the assembly when installed as preferred with the locking arms pointed to the rear;

FIG. 8 is a side cross-sectional view of the details of a preferred locking post and keyhole assembly of the embodiment of FIG. 6 shown in an installation position;

FIG. 9 is a side cross-sectional view of a preferred embodiment of the present invention showing cooperative portions of a preferred locking member and locking aperture in an installation position;

FIG. 10 is a side cross-sectional view of details of the components of the embodiment of FIG. 6 shown in an installed, locked or mounted position;

FIG. 11 is a side cross-sectional view of a preferred embodiment of the present invention of FIG. 9 showing the locking member and locking aperture in an installed, locked or mounted position;

FIG. 12 is a side cross-sectional view of the embodiment of FIG. 11 shown with a preferred embodiment of a release member engaged with a preferred locking tab of a locking member shown in an unlocked or released position;

FIG. 13 is an exploded perspective view of an alternative embodiment of the present invention; and,

FIG. 14 is a perspective view of the embodiment of FIG. 13 with a representative appliance shown on an exemplary support surface in an installed and locked position.

### DETAILED DESCRIPTION OF PREFERRED EMBODIMENTS

Set forth below is a description of what is currently believed to be the preferred embodiments or best representative examples of the inventions claimed. Future and present alternatives and modifications to the embodiments and preferred embodiments are contemplated. Any alternatives or modifications which make insubstantial changes in function, purpose, structure or result are intended to be covered by the claims of this patent.

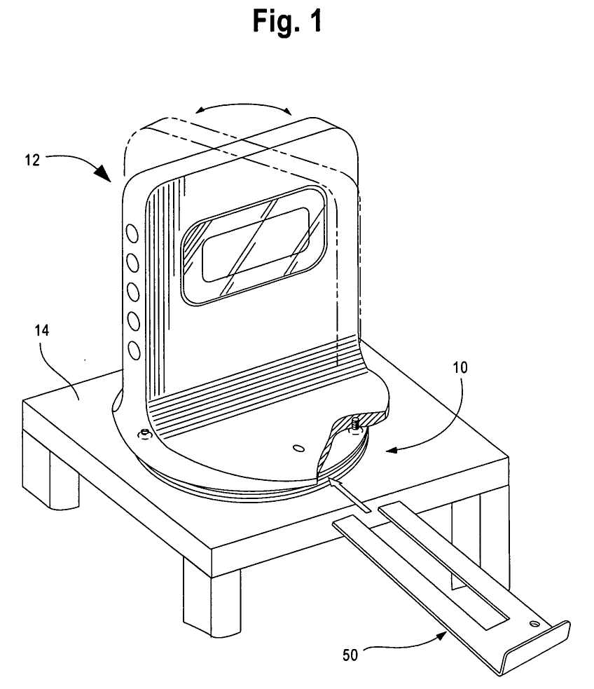

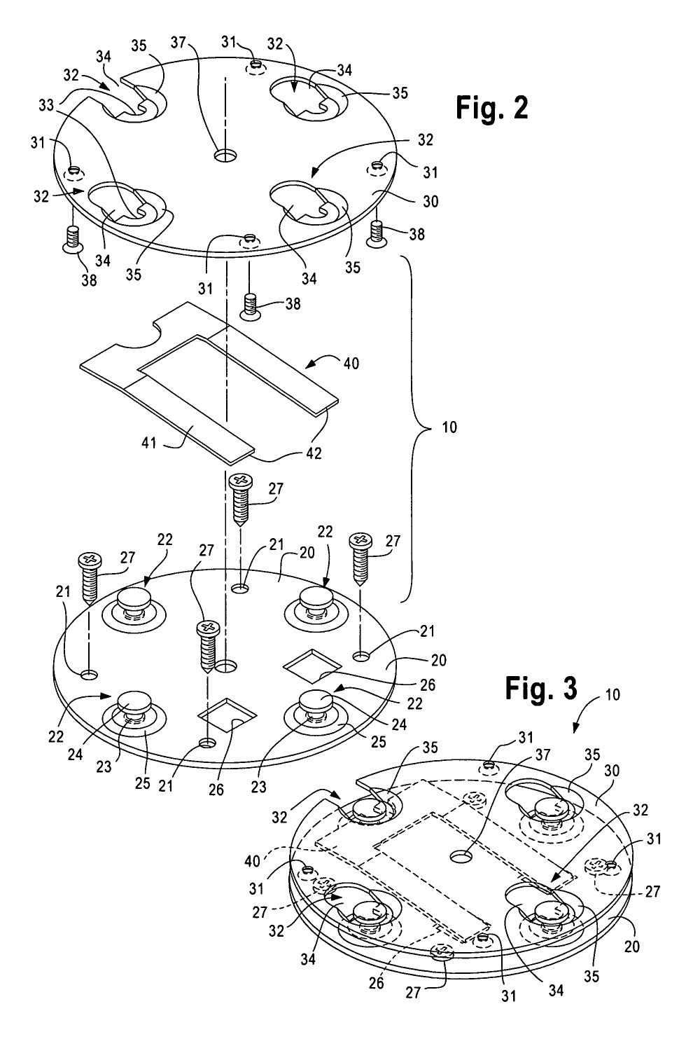

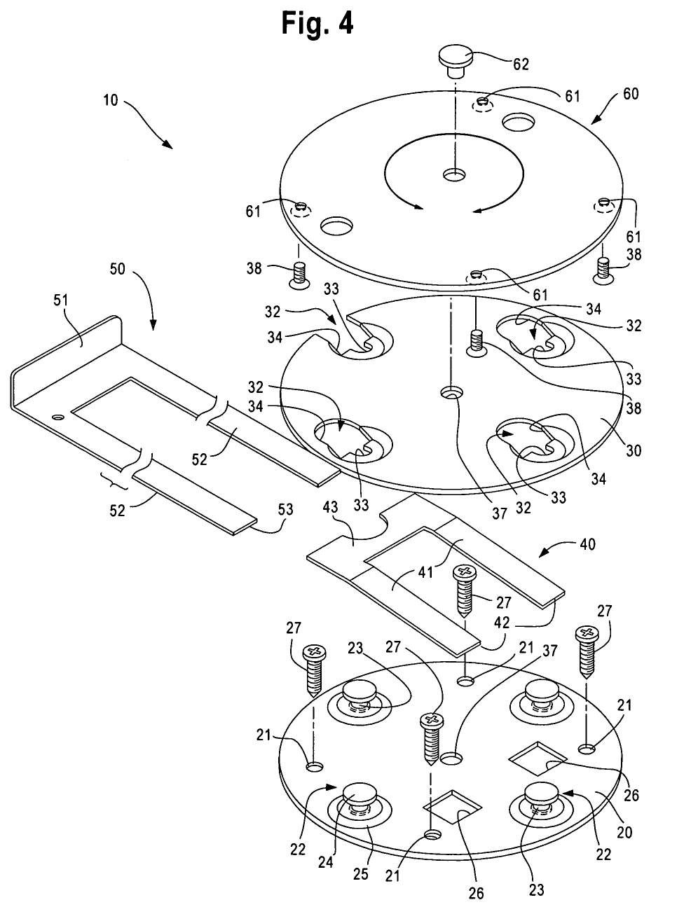

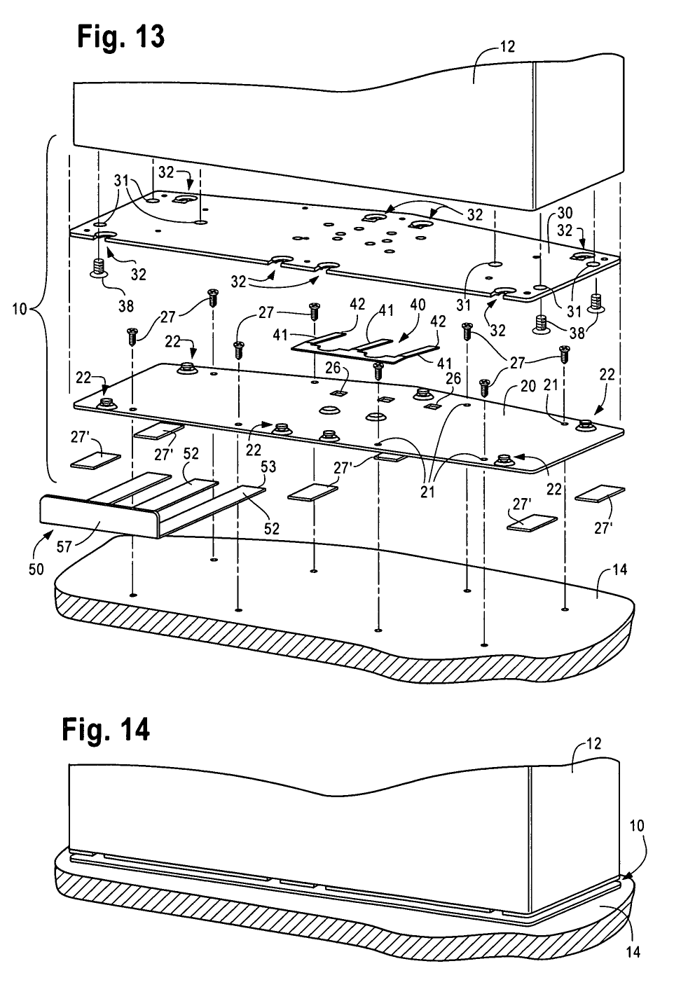

Preferred embodiments of the releasable mounting device of the present invention 10 that are particularly suited for mounting an appliance 12 such as radios, remote controls, televisions and the like is shown in the Figures. For example, FIG. 1 shows a preferred embodiment of the present invention installed on a representative support surface 14 that includes an optional swivel plate 60 (see FIG. 4, exploded view of principal components). As shown, a representative appliance 12, such as a radio, is secured to a support surface 14. Similarly, FIG. 14 shows another embodiment of the present invention 10, this embodiment sized and shaped to secure a television 12 to a support surface 14, such as granite or wood. FIGS. 1 and 4-7 show an embodiment of the present invention 10 having an optional swivel plate 60. FIGS. 2 and 3 show a preferred embodiment of the present invention 10 without a swivel plate or turntable 60 for the appliance 12. FIGS. 13 and 14 also show an alternative embodiment of the present invention 10, also not including an optional swivel plate 60.

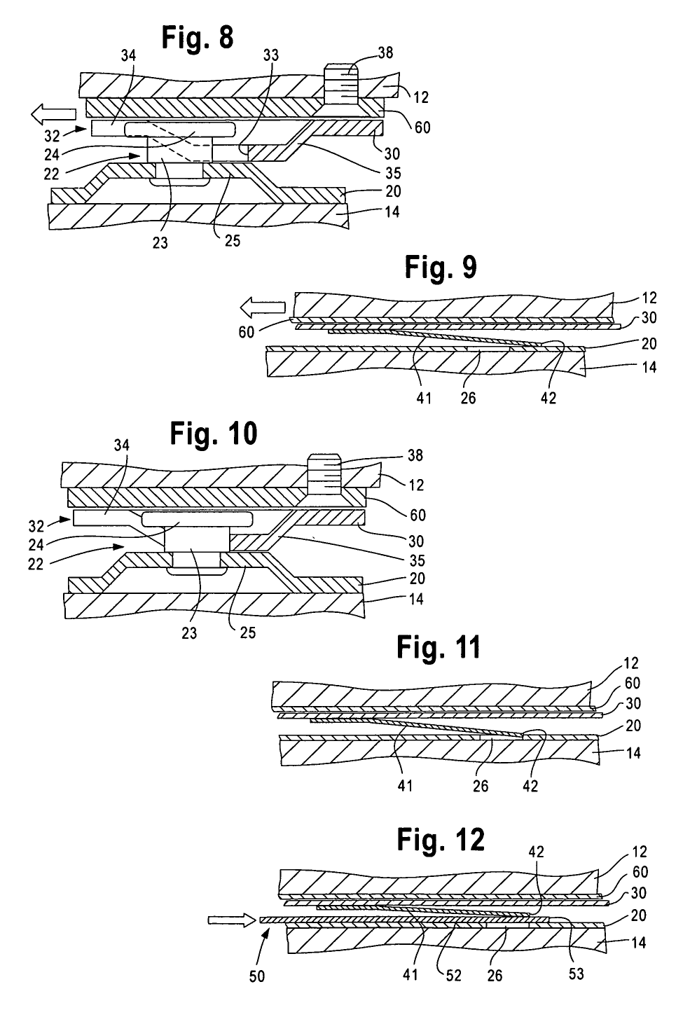

Regardless of the type of appliance 12, support surface 14 or the presence or absence of a swivel plate 60, important aspects of the present invention 10 are shown in FIGS. 8-12. Specifically, FIG. 8 shows the interaction of a preferred locking post 22 with a preferred keyhole 32 in an installation position. FIG. 10 shows the interaction of the preferred locking post 22 with keyhole 32 in an assembled, installed or locked position. FIGS. 9, 11 and 12 show the interaction with a preferred locking aperture 26, locking member 40 and release member 50. Specifically, FIG. 9 is in an installation position, FIG. 11 is in a locked or installed position and FIG. 12 shows a preferred embodiment of a preferred release member 50 unlocking or releasing the locking member 40 so that the mounting plate 30 may be disengaged from the base plate 20.

Referring to FIGS. 2, 4 and 13, a preferred embodiment of the base or base plate 20 is shown in detail. Base 20 is designed to be attached to or engaged with a support surface 14, such as a counter, nightstand or dresser. In the embodiments shown, a plurality of holes 21 are provided in base 20 through which fasteners 27, such as screws, may be used to secure the base 20 to the support surface 14. It will be understood by those of ordinary skill in the art that a variety of fastening means 27 may be used to secure base 20 to the support surface 14, including but not limited to tape (see 27¹, FIG. 13), epoxy, threaded fasteners and the like depending upon the type of support surface 14.

Base 20 is also provided with at least one, but preferably a plurality, of upstanding locking posts 22. Locking post 22 includes a shaft 23 and a head 24. In a preferred embodiment, locking post 22 may also include a platform, raised shoulder and/or spacer 25. Raised shoulder 25, in conjunction with recess 35 of mounting plate 30 as hereinafter described together function to provide a low profile when in an installed and locked position, accommodating the release member 50 between the base 20 and mounting plate 30, and at the same time making unlocking of the two plates difficult without access to the proper release member 50. It will be understood by those of skill in the art that optional shoulder 25 may be formed from part of base 20, or be a separate component. Similarly, locking post 22 may be formed from separate components or be of a unitary construction.

Base plate 20 is further provided with at least one, but preferably more than one, locking aperture 26. Locking apertures 26 are designed to accept or be engaged by locking tabs 42 of locking member 40, as hereinafter described. It will be apparent to those of ordinary skill in the art that locking apertures 26 may be raised members, such as a shoulder or nub, that functions to engage the locking member 40 as hereinafter described. In the preferred embodiment, locking apertures 26 are positioned to the rear to cooperate with locking tabs 42 of locking member 40 as hereinafter described.

With reference to FIGS. 2-5 and 13, a preferred embodiment of a top plate or mounting plate 30 may be better understood. Mounting plate 30 is provided with a plurality of holes 31 to accept threaded fasteners 38 to secure one side of mounting plate 30 to the base or bottom of an appliance. In typical use, the rubber feet (not shown) usually found on appliances 12 are attached to the bottom of the appliance 12 with screws. These screws and/or the feet are removed and the screws used as threaded fastener 38. Of course, those of skill in the art will understand that there are a variety of ways to mount appliance 12 to mounting bracket 30 and/or swivel plate 60.

Mounting plate 30 is provided with at least one, but preferably more than one, recessed keyhole 32 that is designed to coincide and cooperate with corresponding locking post 22 (FIGS. 8 and 10). Keyhole 32 includes a shaft slot 33 to accommodate shaft 23 of locking post 22 and a head opening 34 that is intended to accept head 24 of locking post 22. In a preferred embodiment, a recess or recessed shoulder 35 is provided in mounting plate 30 as part of keyhole 32. In this manner, when locking post 22 is engaged with keyhole 32, the top of head 24 is flush with the top of mounting plate 30 (see FIGS. 3, 5, 8 and 10) and sufficient clearance left for release member 50.

Attached to the underside of mounting plate 30 is a locking member 40 as shown in FIGS. 2-5. In a preferred form, locking member 40 depends from mounting plate 30 and includes a locking arm or arms 41 terminating in ends forming locking tabs 42. An attachment end 43 is provided which may be used to secure locking member 40 to mounting plate 30 by welding. It will be understood by those of ordinary skill in the art that locking member 40 may otherwise be secured to mounting plate 30. Arms 41 project downwardly from mounting plate 30 so that tabs 42 may be engaged by locking aperture 26 of base plate 20 when in the locked or assembled position. In the preferred embodiment, arms 41 are spring biased toward base 20 to function as hereinafter described. Also, in the preferred embodiment, arm 41 points toward the rear of base 20.

A release member 50 may also be provided (FIGS. 4 and 12-13). Release member 50 has a handle 51 and at least one, and preferably a plurality of, prongs or tines 52 that terminate in tips 53. Prongs 52 are of a sufficient length so that when mechanism 50 is inserted between base 20 and mounting plate 30, they reach locking tabs 42 and disengage tabs 42 from locking aperture 26 (see FIG. 12). Preferably, release member 50 has the same number of prongs 52 as there are locking arms 41.

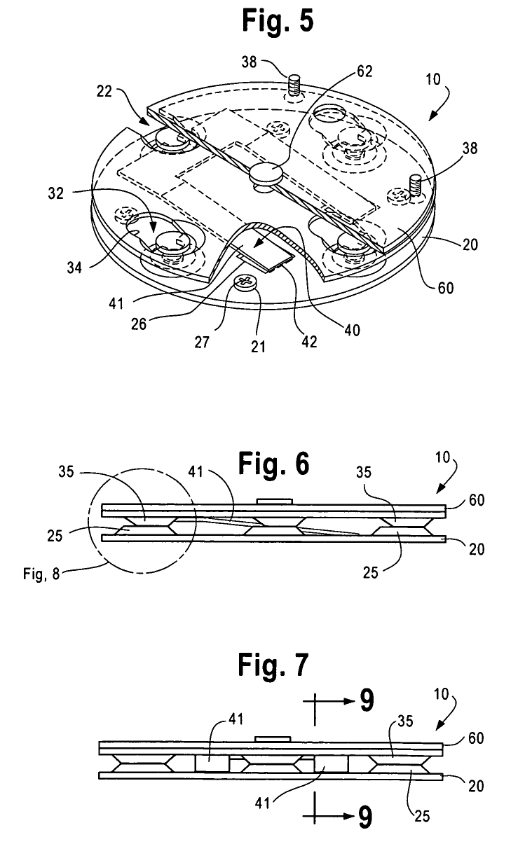

An alternative embodiment of the present inventions includes a swivel plate 60 (see FIGS. 5-12). Swivel plate 60 is preferably the same shape as mounting plate 30. Swivel plate 60 includes holes 61 to accommodate fasteners 63 that secure plate 60 to the desired appliance (not shown). Plate 60 is then pivotably mounted to mounting plate 30 through a center hole 37 using a pin 62 or similar member. The fasteners used to secure swivel plate 60 and base plate 30 to the appliance may be manipulated through the head opening 34 of base plate 30. In this arrangement, holes 31 in base plate 30 are not necessary.

In use, base plate 20 is secured to the support surface 14 using screws 27, tape 27¹ or other means depending upon the type of surface 14. Preferably, locking apertures 26 are placed toward the rear. Mounting plate 30 or swivel plate 60 (if present) is mounted to the bottom of the appliance 12, typically with screws 38. Preferably, the locking arms 42 point from front to back to cooperate with locking apertures 26.

To install or lock the device 10, mounting plate 30 (with appliance 12) is placed on top of base 20 such that the head 24 of locking post 22 is inserted into head opening 34 of keyhole 32. When in this position, the installation, position, locking tabs 42 are biased toward base 20 and about the upper face of base plate 20.

To achieve the mounted or locked position (FIGS. 1 and 14), the appliance is slid forward along with attached mounting plate 30 or swivel plate 60. When the shaft of locking post 22 engages the shaft slot 33 of keyhole 32 as shown in FIG. 10, locking tabs 42 of locking member 40 engaging locking apertures 26 as shown in FIG. 11. As a result, the appliance 12, via mounting plate 30 or swivel plate 60, is locked to base plate 20. In the installed or locked position, mounting plate 30 cannot be lifted or separated from base 20 because head 24 of locking post 22 is restrained in shaft slot 33 of keyhole 32. In addition, because of the engagement of locking tabs 42 with locking apertures 26, mounting plate 30 may not be slid rearward absent the use of release member 50. In such a manner, the present inventions secure an appliance 12 to a support surface 14.

To unlock the mounting plate 30 from base plate 20 (for example, to change the battery in an appliance), release member 50 is inserted between the two components. As shown in FIG. 12, the tips 53 of prongs 52 disengage locking tabs 42 from locking apertures 26. Mounting plate 30 may then be slid rearward so that head 24 of locking post 22 may fit through head opening 34 of keyhole 32. It will be understood by those of skill in the art that there are other means to lock mounting plate 30 to base 22. For example, mounting plate 30 may have apertures and locking member 40 may be attached to base plate 22.

The above description is not intended to limit the meaning of the words used in or the scope of the following claims that define the invention. Rather, it is contemplated that future modifications in structure, function or result will exist that are not substantial changes and that all such insubstantial changes in what is claimed are intended to be covered by the claims. Thus, while preferred embodiments of the present inventions have been illustrated and described, it will be understood that changes and modifications can be made without departing from the claimed invention. In addition, although the term “claimed invention” or “present invention” is sometimes used herein in the singular, it will be understood that there are a plurality of inventions as described and claimed.

Various features of the present inventions are set forth in the following claims.

What is claimed is:

1. An apparatus for securely and releasably mounting an appliance to a support surface, comprising:
a base for engaging said support surface;
at least one upstanding locking post on said base, said locking post having a shaft and a head;
at least one locking aperture on said base;
a mounting bracket securable to said appliance;
at least one keyway on said mounting bracket to cooperate with said at least one locking post; and,
at least one locking tab on said mounting bracket to cooperate with said locking aperture on said base.

2. The support apparatus of claim 1 including a release tool having at least one prong, said prong capable of disengaging said locking tab from said locking aperture.

3. The support apparatus of claim 1 wherein said locking post includes a raised shoulder.

4. The support apparatus of claim 1 wherein said keyway includes a head opening, a shaft slot and a recessed shoulder.

5. The support apparatus of claim 1 wherein a second mounting bracket is provided, said second mounting bracket being securable to said appliance and pivotably mounted to said mounting bracket.

6. The support apparatus of claim 1 wherein said locking aperture is a raised member.

7. A security mounting apparatus to secure an appliance to a support surface comprising:
a base plate for attachment to said support surface, said base including at least one locking post having a shaft and a head and said base including at least one locking member;
a mounting bracket securable to said appliance, said mounting bracket including at least one keyway slidably engagable with said at least one locking post and at least one locking tab depending from said mounting bracket engagable with said locking member; and,
a release member having at least one prong which is capable of disengaging said locking tab from said locking member.

8. The apparatus of claim 7 wherein a second mounting bracket is provided, said second mounting bracket securable to said appliance and securable to said mounting bracket.

9. A mounting apparatus for selectively locking and unlocking an appliance on a support surface comprising:
a base for engaging said support surface, including at least one locking post having a head and a shaft and including at least one locking aperture;
a mounting bracket securable to said appliance, said mounting bracket having at least one keyway slidably engagable with and capable of retaining said at least one locking post;
at least one locking member depending from said mounting bracket and engagable with and releasable from said locking aperture; and,
a release member for selectively releasing said at least one locking member from said at least one locking aperture.

10. The apparatus of claim 10 including a second mounting bracket securable to said appliance and which is pivotably mounted to said mounting bracket such that said appliance may be rotated on said mounting apparatus.

11. The apparatus of claim 7 wherein said locking member is included on said mounting bracket and said locking tab is appended to said base plate.

12. The apparatus of claim 1 wherein said at least one locking aperture is on said mounting bracket and said locking tab is on said base.

13. The apparatus of claim 9 wherein said locking member depends from said base and said locking aperture is on said mounting bracket.

14. The apparatus of claim 9 wherein said locking aperture is a raised member or protrusion capable of engaging said locking member.
